(19) United States
(12) Patent Application Publication
(10) Pub. No.: US 2009/0322560 A1
(43) Pub. Date: Dec. 31, 2009

(54) IN-VEHICLE ALERT DELIVERY MAXIMIZING COMMUNICATIONS EFFICIENCY AND SUBSCRIBER PRIVACY

(75) Inventors: Steven C. Tengler, Grosse Pointe Park, MI (US); Richard A. Johnson, Rochester Hills, MI (US); Gary A. Watkins, Royal Oak, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: GENERAL MOTORS CORPORATION, Detroit, MI (US)

(21) Appl. No.: 12/165,294

(22) Filed: Jun. 30, 2008

(51) Int. Cl. G08G 1/09

(52) U.S. Cl. 340/905

(57) ABSTRACT

A system and method are provided for enhancing subscriber privacy while delivering location-based in-vehicle alerts to the subscribers of a mobile traffic reporting system by disassociating subscriber information from location information transmitted by a traffic probe vehicle. In various examples, the in-vehicle alerts include Flash Flood alerts, Hurricane alerts, Amber alerts, as well as non-crisis alerts, such as traffic hotspots, locations of inexpensive gas stations, and various points of interest.

### FIELD OF THE INVENTION

This invention relates generally to the field of telematics and more specifically to delivering in-vehicle alerts while ensuring communications efficiency and subscriber privacy.

### BACKGROUND OF THE INVENTION

A growing number of modern vehicles incorporate telematics devices for providing navigational assistance in a mobile environment. As part of providing navigational assistance, a vehicle telematics unit typically correlates road network data with the vehicle's current location and conveys vehicle's location information and/or driving directions to the driver via a graphical interface. In addition to conveying navigational data, it may be desirable to provide telematics system subscribers with location-based services, including various alerts specific to a vehicle's locale.

Alert delivery methods such as system-wide broadcasting of alerts are expensive due to the cost of initiating transmissions to all system subscribers. System-wide broadcasts are also inefficient since broadcasted alerts may be local in nature and will not always be relevant to the vehicle's current location, or vehicular condition such as the vehicle being low on fuel. Furthermore, subscriber privacy concerns with respect to the use of location-based data complicate delivery of location-based alerts.

### BRIEF SUMMARY OF THE INVENTION

A system and method are provided for enhancing subscriber privacy while delivering location-based in-vehicle alerts to the subscribers of a mobile traffic reporting system by disassociating subscriber information from location information transmitted by a traffic probe vehicle.

In one aspect of the invention, a method is provided comprising (a) receiving input of an alert configuration from the subscriber, (b) disassociating subscriber information from traffic probe information by assigning a unique identifier to a traffic probe message originating from the traffic probe vehicle, the traffic probe information in the message comprising the vehicle's location, speed, and direction of travel, (c) receiving the traffic probe message with the unique identifier, (d) filtering a plurality of alerts based on the alert configuration corresponding to the traffic probe message having the unique identifier, and (e) delivering one or more filtered alerts to the traffic probe vehicle.

### BRIEF DESCRIPTION OF THE DRAWINGS

FIG. 1 is a schematic diagram illustrating a system for delivery of in-vehicle telematics services, as contemplated by an example of the present invention;

FIG. 2 is a schematic diagram illustrating a traffic probe vehicle traveling inside a geographical area associated with one or more active alerts, in accordance with an example of the invention; and

FIG. 3 is a flow chart illustrating a method for enhancing subscriber privacy while delivering in-vehicle alerts to a traffic probe vehicle associated with a subscriber, in accordance with an example of the invention.

### DESCRIPTION OF AN EXEMPLARY EMBODIMENT

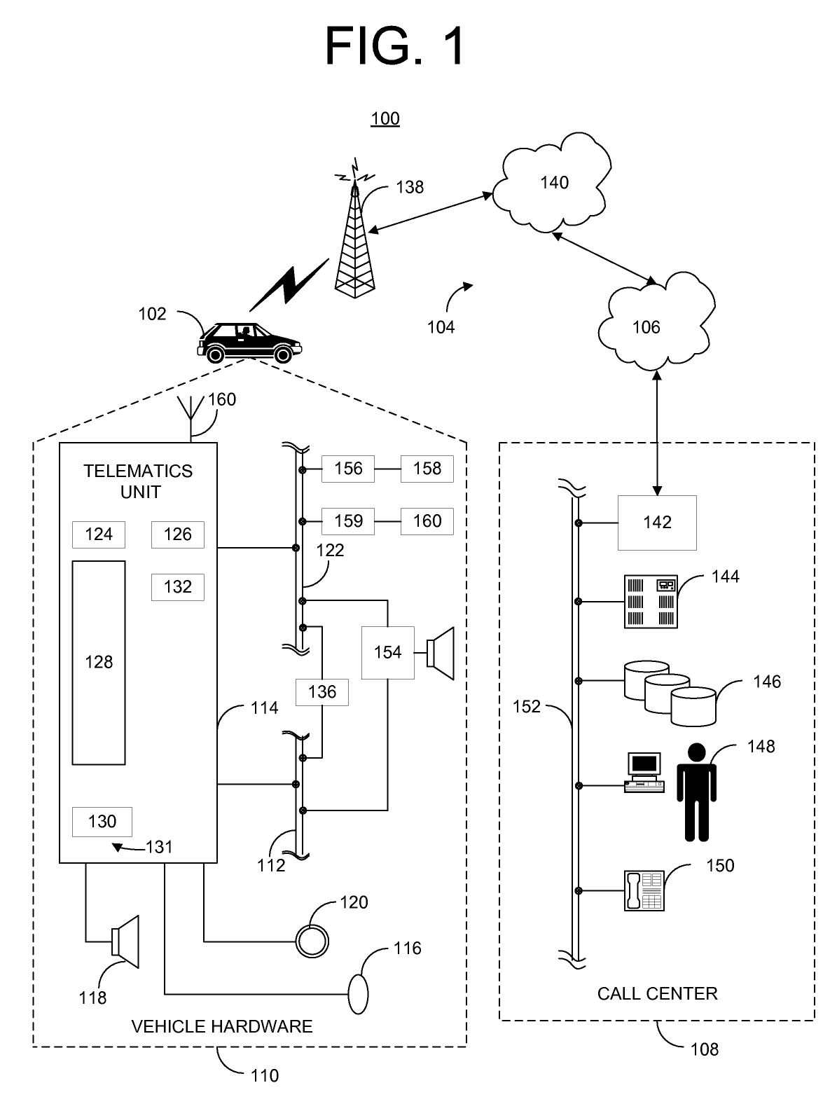

With reference to FIG. 1 there is shown an example of a communication system 100 that may be used with the present method and generally includes a vehicle 102, a wireless carrier system 104, a land network 106 and a data or call center 108. It should be appreciated that the overall architecture, setup and operation, as well as the individual components of a system such as that shown here are generally known in the art. Thus, the following paragraphs simply provide a brief overview of one such exemplary information system 100, however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128, one or more types of electronic memory 130 having stored thereon software 131, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, videogames and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 will include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic pushbutton used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 159, connected to various sensor interface modules 134 are operatively connected to the vehicle bus 122. Examples of vehicle sensors include but are not limited to gyroscopes, accelerometers, magnetometers, emission detection and/or control sensors, and the like. Example sensor interface modules 134 include powertrain control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber of other optical network, a cable network, other wireless networks such as wireless local networks (WLANs) or networks providing broadband wireless access (BWA), or any combination thereof.

Call center 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

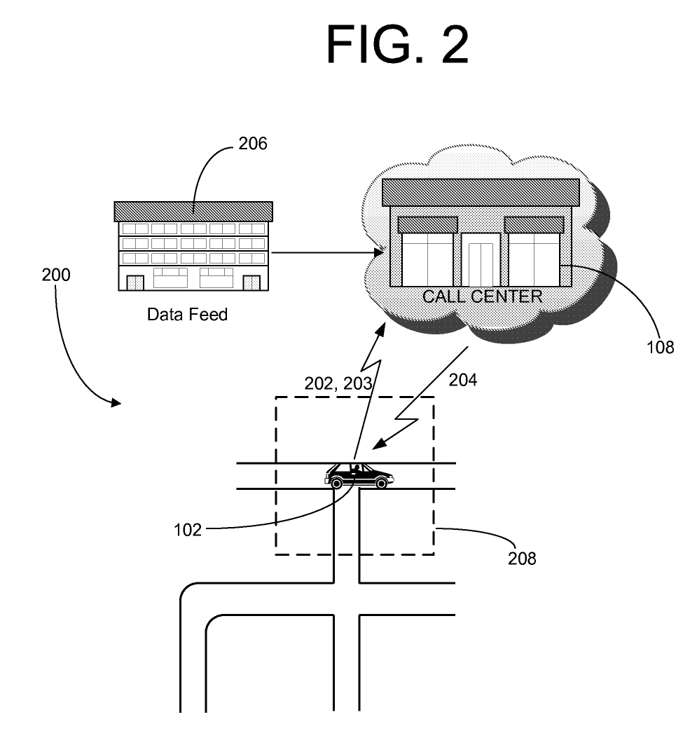

Referring to FIG. 2, a traffic probe collection and in-vehicle alert delivery system 200 is shown. The subscriber associated with the vehicle 102 opts in for participating in a fleet of traffic reporting vehicles, which periodically initiate communication sessions with the call center 108 to automatically upload traffic probes 202. The traffic probes 202 include information on the vehicle's location (e.g., latitude and longitude), speed, direction of travel, as well as other information described in a commonly owned U.S. Pat. No. 7,246,007 to Ferman, entitled “System and Method of Communicating Traffic Information,” which is incorporated herein by reference in its entirety for everything that it teaches. To provide the vehicles 102, 103 with relevant location-based alerts 204, the call center 108 collects alert information from a plurality of data feeds 206 and correlates the alerts with vehicle location collected from the traffic probes 202. Exemplary data feeds 206 include the National Weather Service, police/fire data centers for delivery of weather and/or emergency-related alerts, as well as a plurality of geographical information systems and databases and/or Internet services.

In order to enhance subscriber privacy during a communication session, the traffic probes 202 transmitted by each vehicle 102 are disassociated from the information directly identifying the subscriber and the vehicle, such as account, subscriber identity, and vehicle information. To this end, the traffic probes uploaded from a given vehicle include a unique traffic probe identification number (traffic probe id) 203 associated with all traffic probes originating from such vehicle. The traffic probe id 203 may be a randomly assigned identifier having a predetermined number of digits, or an identifier selected from a pool of unique identifiers of fixed length. The database 146 (FIG. 1) at the call center 108 stores a table cross referencing a vehicle-specific traffic probe id 203 with subscriber information (e.g., subscriber's name, residential or garage address and account number) for customizing in-vehicle alert delivery in accordance with pre-set alert configurations for a given subscriber, as discussed in more detail below.

In one example, when the call center 108 receives a transmission of a traffic probe 202 from the vehicle 102 (e.g., via a wireless carrier system 104), the traffic probe id 203 of the vehicle 102 is cross-referenced with the subscriber identification table at the database 146. The call center 108 also receives information on the alert configuration settings previously selected by the subscriber. When a subscriber opts in for participating in the location-based services (LBS), he or she creates an alert configuration specifying which types of alerts may be delivered to the subscriber's vehicle. Each alert configuration is assigned a unique configuration number. For example, an alert configuration {110} includes delivery of Amber alerts and Flash Flood alerts, but excludes delivery of Hurricane alerts. The call center 108 receives input of Flash Flood and Hurricane alerts from the National Weather Service, while the Amber alerts are sourced from an emergency service data center, such as a police/fire call center. An exemplary Amber alert includes a child abduction message, such as: “Child abducted. Last seen in a vehicle with license plate number 1234”. Additional alerts include non-crisis alerts, such as traffic hotspots, locations of low-cost gas stations and various points of interest. Other alerts, such as tornado and severe thunderstorm watches or warnings may be included. Homeland security related alerts may also be included.

In one example, when the vehicle 102 establishes a telematics setup data session with the call center 108, the call center 108 pushes the alert configuration number specific to the subscriber to the memory of the telematics unit 114. During the first traffic probe upload, the telematics unit 114 provides the relevant alert configuration number(s) to the call center 108 for customized alert processing. In one example, the call center 108 periodically assigns a new temporary traffic probe id 203 to the vehicle 102, such as daily, and/or when the traffic probe id 203 is no longer associated with one or more unexpired alerts 204. Alternatively, the call center 108 permanently associates a given vehicle 102 with its traffic probe id 203. Upon receipt of the traffic probe id 203, the call center 108 cross-references the traffic probe id 203 with the subscriber records in the database 116 and determines whether there are active alerts due to be delivered to the subscriber in the vicinity of the traffic probe and in accordance with subscriber's alert configuration number.

To reduce the network load and transmission costs for delivering alerts 204, the call center 108 keeps track of previously delivered alerts 204 for a given traffic probe id 203 and foregoes delivery of duplicate alerts. The call center 108 assigns an alert identification number for each alert 204 and keeps track of delivered alert numbers for a given traffic probe id 203. For example, a Flash Flood alert within a particular geographical zone 208 is assigned an alert ID{010110}, while an Amber alert is assigned an alert ID{100001}. Hence, if the vehicle re-enters a geographical zone 208, the call center 108 foregoes re-delivery of duplicate alerts based on the list of delivered alert numbers for the corresponding traffic probe id 203. Alternatively, if a given traffic probe id 203 received active alerts for a given geographical area 208 in accordance with its alert configuration, the call center 108 foregoes re-delivery of all alerts if the vehicle 102 re-enters the same geographical area 208.

Furthermore, alerts 204 are location/geographic area specific and preferably include an expiration time and date. Therefore, upon expiration of an alert, the call center 108 purges the corresponding alert number from the list of alerts transmitted to a given traffic prove id 203. Purging of expired alerts helps avoid permanent tracking of alert number—traffic probe id pairs, which may correspond to subscriber's movement patterns.

In one example, the call center 108 processes alert configurations transmitted with traffic probe id information and selects relevant alerts for the subscriber in real-time to ensure delivery of alerts 204 while the vehicle 102 is in the relevant geographical area. In this case, the vehicle 102 initiates the transmission of a traffic probe id 203 via a two-way communication session, where in response to the vehicle's transmission of the traffic probe id 203 the call center 108 downloads relevant active alerts into the memory of the telematics unit 114. In another example, the call center 108 processes the alert configuration settings received from the vehicle 102 off-line to further increase subscriber anonymity by stripping off time stamp data from the traffic information and promptly initiating a separate transmission of alerts 204 in accordance with the received alert configuration number. In yet another example, the telematics unit 114 transmits an acknowledgement to the call center 108 upon successful receipt of one or more transmitted alerts 204.

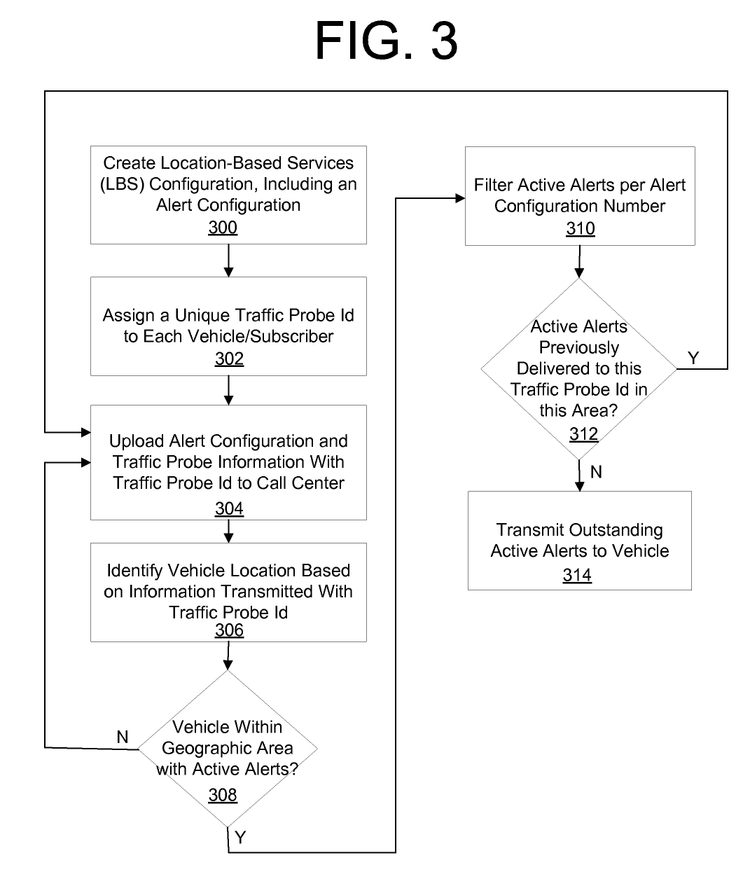

Referring to FIG. 3, a method for delivering in-vehicle alerts in accordance with one example of the invention is shown. In step 300, the subscriber creates an LBS configuration, including a preferred alert type delivery configuration (identified by an alert configuration number). In step 302, the call center 108 assigns a unique traffic probe id 203 to each vehicle 102. In step 304, the vehicle 102 periodically uploads traffic information and the alert configuration number associated with its traffic probe id 203 to the call center 108. The call center 108 identifies vehicle location based on the received traffic probe information and determines whether the vehicle 102 is within a geographic area 208 associated with one or more active alerts, steps 306-308. If so, the call center filters the active alerts to be delivered to the vehicle 102 in accordance with the received alert configuration settings, step 310. If the filtered list of alerts within the geographical area 208 includes alert numbers previously delivered to the vehicle corresponding to the traffic probe id 203, the process returns to step 304 for monitoring additional incoming traffic probe information. Otherwise, the call center 108 transmits outstanding active alerts to the vehicle 102.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. In a mobile traffic reporting system, a method for enhancing subscriber privacy while delivering in-vehicle alerts to a traffic probe vehicle associated with a subscriber, the method comprising:
receiving input of an alert configuration from the subscriber;
disassociating subscriber information from traffic probe information by assigning a unique identifier to a traffic probe message originating from the traffic probe vehicle, the traffic probe information in the message comprising the vehicle's location, speed, and direction of travel;
receiving the traffic probe message with the unique identifier;
filtering a plurality of alerts based on the alert configuration corresponding to the traffic probe message having the unique identifier; and
delivering one or more filtered alerts to the traffic probe vehicle.

2. The method of claim 1 wherein each of the plurality of alerts comprises one of a flash flood alert, a hurricane alert, an amber alert, a traffic alert, and a point of interest alert.

3. The method of claim 1 further comprising identifying whether the traffic probe vehicle is in a location corresponding to the plurality of alerts.

4. The method of claim 3 further comprising foregoing multiple deliveries of the one or more filtered alerts when the traffic probe vehicle is in the location.

5. The method of claim 1 further comprising periodically assigning a new unique identifier to the traffic probe message originating from the vehicle.

6. The method of claim 1 further comprising receiving the traffic probe message and delivering the one or more filtered alerts during the course of a single communication session.

7. The method of claim 1 further comprising:
removing time stamp information from the traffic probe message; and
initiating a separate communication session for delivering the one or more filtered alerts.

8. The method of claim 1 further comprising transmitting an acknowledgement message from the traffic probe vehicle, the acknowledgment message comprising a confirmation of delivery of the one or more filtered alerts.

9. In a mobile traffic reporting system, a method for enhancing subscriber privacy while delivering in-vehicle alerts to a traffic probe vehicle associated with a subscriber, the method comprising:
receiving input of an alert configuration from the subscriber;
disassociating subscriber information from traffic probe information by assigning a unique identifier to a traffic probe message originating from the traffic probe vehicle, the traffic probe information in the message comprising the vehicle's location, speed, and direction of travel;
in a first communication session, receiving the traffic probe message with the unique identifier;
filtering a plurality of alerts based on the alert configuration corresponding to the traffic probe message having the unique identifier;
removing time stamp information from the traffic probe message; and
in a second communication session, delivering the one or more filtered alerts to the traffic probe vehicle.

10. The method of claim 9 wherein each of the plurality of alerts comprises one of a flash flood alert, a hurricane alert, an amber alert, a traffic alert, and a point of interest alert.

11. The method of claim 9 further comprising identifying whether the traffic probe vehicle is in a location corresponding to the plurality of alerts.

12. The method of claim 11 further comprising foregoing multiple deliveries of the one or more filtered alerts when the traffic probe vehicle is in the location.

13. The method of claim 9 further comprising periodically assigning a new unique identifier to the traffic probe message originating from the vehicle.

14. The method of claim 9 further comprising transmitting an acknowledgement message from the traffic probe vehicle, the acknowledgment message comprising a confirmation of delivery of the one or more filtered alerts.

15. An in-vehicle alert delivery system comprising:
a traffic probe vehicle associated with a subscriber to a mobile traffic reporting system, the traffic probe vehicle periodically transmitting a traffic probe message; and
a call center for delivering in-vehicle alerts to the traffic probe vehicle in response to receiving the traffic probe message, wherein the call center, disassociates subscriber information from traffic probe information by assigning a unique identifier to the traffic probe message and filtering a plurality of alerts based on a predetermined alert configuration, the predetermined alert configuration corresponding to the traffic probe message having the unique identifier.

16. The system of claim 15 wherein each of the plurality of alerts comprises one of a flash flood alert, a hurricane alert, an amber alert, a traffic alert, and a point of interest alert.

17. The system of claim 15 wherein the call center identifies whether the traffic probe vehicle is in a location corresponding to the plurality of alerts.

18. The system of claim 17 wherein the call center foregoes multiple deliveries of the one or more filtered alerts when the traffic probe vehicle is in the location.

19. The system of claim 15 wherein the unique identifier is temporary.

20. The system of claim 15 wherein the call center removes time stamp information from the traffic probe message and initiates a separate communication session for delivering the one or more filtered alerts.
